(19) United States
(12) Patent Application Publication
(10) Pub. No.: US 2010/0264795 A1
(43) Pub. Date: Oct. 21, 2010

(54) COLOR TEMPERATURE ADJUSTABLE LAMP

(75) Inventor: Cheng-Hsi MIAO, Taipei (TW)

Correspondence Address: LOWE HAUPTMAN HAM & BERNER, LLP, 1700 DIAGONAL ROAD, SUITE 300, ALEXANDRIA, VA, 22314, US

(73) Assignee: AETHER SYSTEMS INC., Taipei (TW)

(21) Appl. No.: 12/467,571

(22) Filed: May 18, 2009

(30) Foreign Application Priority Data
Apr. 21, 2009 (TW) 098113205

(51) Int. Cl. H01J 61/94

(52) U.S. Cl. 313/1

(57) ABSTRACT

A color temperature adjustable lamp is created through mixture of the color temperature of a low color temperature white LED and a high color temperature white LED. A plurality of different color temperatures in between the color temperature of the low color temperature white LED and the color temperature of the high color temperature white LED can be created to emit. The color temperature is also known as Correlated Color Temperature (CCT).

### FIELD OF THE INVENTION

This invention relates to a color temperature adjustable lamp, especially to a lamp to which the color temperature is adjusted by controlling the currents of a low color temperature white LED and a high color temperature white LED.

### BACKGROUND

FIG. 1 is a prior art. It is well known that color can have a profound effect on how we feel both mentally and physically. The ancient Egyptians as well as the Native American Indians used color and colored light to heal. Blue color represents peace; Green color represents nature; Purple color represents royalty; and Yellow color represents happiness . . . etc., that is to say, different color temperature creates different atmosphere. In other words, people may like to have white light with a bit of yellow at one time, but may like to have white with a bit of blue at another time. A prior art of a color temperature adjustable lamp is shown in FIG. 1, a red (R) light emitted diode (LED), a green (G) light emitted diode, and a blue (B) light emitted diode are mounted on a substrate 10 to be adjusted for producing a desired color temperature to emit. Glue 15 encloses the three LEDs R, G, and B as a protection. The red LED electrically couples to a common electrode 124 and a first electrode lead 121. The green LED electrically couples to the common electrode 124 and a second electrode lead 122. The blue LED electrically couples to the common electrode 124 and a third electrode lead 123. The traditional color temperature adjustable lamp needs to control currents of three diodes R, G; and B to obtain desired color temperature atmosphere. To adjust three current variable components is a little complicated to an end user. It is desired to develop a color temperature adjustable lamp with lesser adjustable variable components.

### BRIEF DESCRIPTION OF THE DRAWINGS

FIG. 1 is a Prior Art

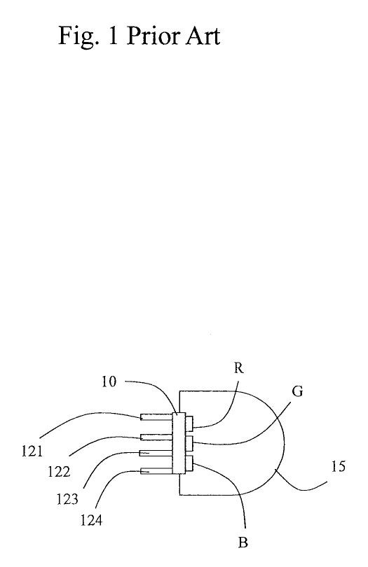

FIG. 2 is an embodiment according to the present invention.

### DETAILED DESCRIPTION OF EMBODIMENTS

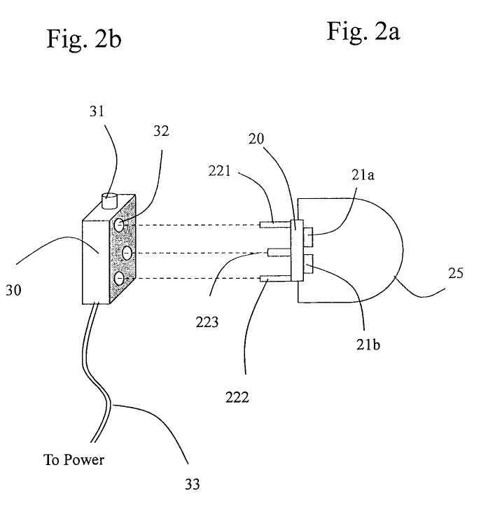

FIG. 2 is an embodiment according to the present invention. A low color temperature white light emitted diode (LED) 21a and a high color temperature white light emitted diode (LED) 21b are mounted on a substrate 20 which can be a circuit board or a lead frame to be adjusted for producing a desired color temperature to emit.

Glue or a glass lamp shade 25 encloses the white light emitted diodes 21a, 21b as a protection. The low color temperature white LED 21a electrically couples to a common electrode lead 223 and a first electrode lead 221. The high color temperature white LED 21b electrically couples to the common electrode lead 223 and a second electrode lead 222. A control unit 30 controls the light intensity of the white LEDs 21a and 21b, which has three mounting holes 32 with electrical contacts inside (not shown) each electrically coupling to one of the electrode leads 221, 222, and 223 when the three electrode leads 221, 222, and 223 are inserted into the holes 32. A power cord 33 electrically couples the control unit 30 to a power (not shown). A turning knob 31 for user to adjust the currents of the low color temperature LED 21a and the high color temperature LED 21b to produce different color temperature for the lamp to emit.

TABLE I
color temperature vs. color display

| Color temperature (K) | Color display |
|---|---|
| 2500 K~4000 K | White (colorless) light with a bit of |
| | yellow-red light. |
| 4000 K~5500 K | White (colorless) light with a bit of blue light |
| 5500 K~7000 K | White (colorless) light with a bit of gray light |
| 7000 K~8000 K | White (colorless) light with a bit of green light |

Table 1 shows a relationship between color temperatures vs. color display. While under low color temperature (2500K˜4000K), it appears white (colorless) light with a bit of yellow-red light. While under middle low color temperature (4000K˜5500K), it appears white (colorless) light with a bit of blue light. While under middle high color temperature (5500K˜7000K), it appears white (colorless) light with a bit of gray light. While under high color temperature (7000K˜800K), it appears white with a bit of green.

TABLE II
Mixture of Color Temperatures

| Color | | | | | | |
|---|---|---|---|---|---|---|
| Temperatures | Components Percentage of Mixture | | | | | |
| 2500 K | 0% | 20% | 40% | 60% | 80% | 100% |
| 6000 K | 100% | 80% | 60% | 40% | 20% | 0% |
| Mixed | 6000 K | 5300 K | 4600 K | 3900 K | 3200 K | 2500 K |
| Color | | | | | | |
| temperatures | | | | | | |

Table II shows an example of mixture of a low color temperature of 2500K and a high color temperature of 6000K. The resulted color temperatures are calculated by weighted average and shown respectively in the bottom row: with 6000K, 5300K, 4600K, 3900K, 3200K, and 2500K respectively when the low color temperature of 2500K contributes 0%, 20%, 40%, 60%, 80%, and 100% and 6000 k contributes complementary 100%, 80%, 60%, 40%, 20% and 0% each in the combinations. The calculation of mixed color temperatures are listed as follows:

2500K*0%+6000K*100%=6000K

2500K*20%+6000K*80%=5300K

2500K*40%+6000K*60%=4600K

2500K*60%+6000K*40%=3900K

2500K*80%+6000K*20%=3200K

2500K*100%+6000K*0%=2500K

The above calculation is based on linear relationship of color temperatures for white LEDs, however in actual situation; the color temperature is not ideally linear for a white LED. The actual color temperatures displayed for a product may have somewhat deviation from the value calculated as above.

While several embodiments have been described by way of example, it will be apparent to those skilled in the art that various modifications may be made without departing from the spirit of the present invention. Such modifications are all within the scope of the present invention, as defined by the appended claims.

What is claimed is:

1. A color temperature adjustable lamp, comprising:
a low color temperature white LED;
a high color temperature white LED; and
a control unit, controlling light intensities of the LEDs.

2. A color temperature adjustable lamp as claimed in claim 1, further comprising a substrate, to which said LEDs are mounted.

3. A color temperature adjustable lamp as claimed in claim 2, wherein said substrate is a circuit board or a lead frame.

4. A color temperature adjustable lamp as claimed in claim 1, further comprising a protection unit to enclose said LEDs.

5. A color temperature adjustable lamp as claimed in claim 4, wherein said protection unit is glue or a glass lamp shade.

6. A color temperature adjustable lamp as claimed in claim 1, further comprising: three electrode leads respectively electrically coupling to said LEDs.

7. A color temperature adjustable lamp as claimed in claim 1, wherein said control unit controls currents of said LEDs.

8. A color temperature adjustable lamp as claimed in claim 1, wherein said low color temperature white LED having a color temperature of 2500K˜3500K.

9. A color temperature adjustable lamp as claimed in claim 1, wherein said high color temperature white LED having a color temperature of 5000K˜6000K.

10. A method for adjusting color temperature for a lamp, comprising:
preparing a low color temperature white LED;
preparing a high color temperature white LED; and
preparing a control unit, for controlling light intensities of said LEDs.

11. A method for adjusting color temperature for a lamp as claimed in claim 10, wherein said low color temperature white LED having a color temperature of 2500K˜3500K.

12. A method for adjusting color temperature for a lamp as claimed in claim 10, wherein said high color temperature white LED having a color temperature of 5000K˜6000K.
